(19) United States
(12) Patent Application Publication
(10) Pub. No.: US 2014/0042740 A1
(43) Pub. Date: Feb. 13, 2014

(54) METHODS AND SYSTEMS FOR CLADDING SURFACES OF COMPONENTS USING HOT WIRE LASER WELDING

(71) Applicant: LINCOLN GLOBAL, INC., City of Industry, CA (US)

(72) Inventor: Mike BARRETT, North Royalton, OH (US)

(73) Assignee: LINCOLN GLOBAL, INC., City of Industry, CA (US)

(21) Appl. No.: 13/802,850

(22) Filed: Mar. 14, 2013

Related U.S. Application Data
(60) Provisional application No. 61/681,934, filed on Aug. 10, 2012.

(51) Int. Cl. F16L 13/02; B23K 31/02

(52) U.S. Cl. CPC F16L 13/0209; B23K 31/027
USPC 285/288.1; 228/203

(57) ABSTRACT

A system and method of joining workpieces is provided where a clad layer is deposited in between the components and a weld bead is providing such that it contacts the clad layer. The system and method provided minimizes the heat input into the components by using the clad layers to provide the joining strength between the pipe components.

### PRIORITY

The present application claims priority to U.S. Provisional Patent Application No. 61/681,934 filed Aug. 10, 2012, which is incorporated herein by reference in its entirety.

### TECHNICAL FIELD

This invention relates to systems and methods of joining components, including cylindrical components. More specifically, the subject invention relates to systems and methods for joining components, workpieces and pipes with a hot wire system and process.

### BACKGROUND

Shown in FIG. 1A is an illustrative embodiment of a known and typical weld joint 10 between a first pipe 12 and second pipe 14. The second pipe 14 is inserted within the first pipe 12 and a consumable electrode or wire is applied to form a fillet weld 16 to join the first and second pipes 12, 14. The fillet weld 16 may be formed by any know welding or joining technique, including known arc welding or “hot wire” welding techniques. The joining process and weld metal formation introduces heat into the joint 10 and more particularly the pipes 12, 14 to generate a heat affected zone (HAZ) 18 in each of the pipes 12, 14 proximate the weld metal. As described in U.S. Pat. No. 6,336,583, which is incorporated herein by reference in its entirety, is the portion of the base metal in each of the pipes 12, 14 that has not been melted, but in which the microstructure and mechanical properties have been altered by the heat introduced by the joining process. To rectify and undesirable alterations, the pipe and joints may be subjected to a heat treatment process.

Further limitations and disadvantages of conventional, traditional, and proposed approaches will become apparent to one of skill in the art, through comparison of such approaches with embodiments of the present invention as set forth in the remainder of the present application with reference to the drawings.

### SUMMARY

Embodiments of the present invention provide for systems and methods for joining two components in which one component is inserted in a recess of another, or positioned in an otherwise overlapping manner, such as a lap joint.

As an initial matter, it should be noted that even though the following discussion utilizes the joining of pipes as an exemplary embodiment, aspects of the present invention can be utilized in joining work pieces in many different configurations, including but not limited to lap joints, butt joints, angles joints, etc. Therefore, the following exemplary discussion is not intended to be limited to simply pipe joints, as the embodiments and aspects discussed herein can be equally employed in multiple joint types without departing from the scope and spirit of the present invention. Therefore, even though the following discussion utilizes a pipe embodiment, aspects of the present invention are not limited in this regard.

Turning now to an exemplary embodiment of the present invention, provided are systems and methods for joining a first cylindrical component having a recess with a second cylindrical component disposed in the recess. Accordingly, the subject systems and methods are suited for joining two pipes. In one embodiment, a first pipe component includes an inner surface defining a passageway and a second pipe component is at least partially disposed in the passageway such that a portion of the first pipe component overlaps the second pipe component. Disposed between the overlapping regions of the first and second pipe components is a cladding material that defines the interface between the first and second pipe component. A fillet weld joins the first and second pipe components, and a portion of the fillet weld extends along the clad interface. In one aspect of the subject system and method, the clad interface essentially serves as a heat sink so as to minimize or eliminate the effects of the HAZ in the base materials of the first and second pipe components. Thus, in one particular aspect of the subject system and method the need for post-weld heat treatment of the joined first and second pipes can be eliminated.

Another particular embodiment of a pipe joint assembly includes a first cylindrical pipe component having an inner surface defining a first pipe passageway. An internal clad is formed along the inner surface of the first pipe component. A second cylindrical pipe component having an outer surface with an external clad disposed about the outer surface is disposed within the first pipe component. The internal and external clad define an interface between the first and second pipe components. A fillet weld extends between and joins the first and the second pipe components. At least a portion of the fillet weld extends along the internal and external clad.

These and other features of the claimed invention, as well as details of illustrated embodiments thereof, will be more fully understood from the following description and drawings.

### BRIEF DESCRIPTION OF THE DRAWINGS

The above and/or other aspects of the invention will be more apparent by describing in detail exemplary embodiments of the invention with reference to the accompanying drawings, in which:

FIGS. 1A-1B is a known pipe joint assembly;

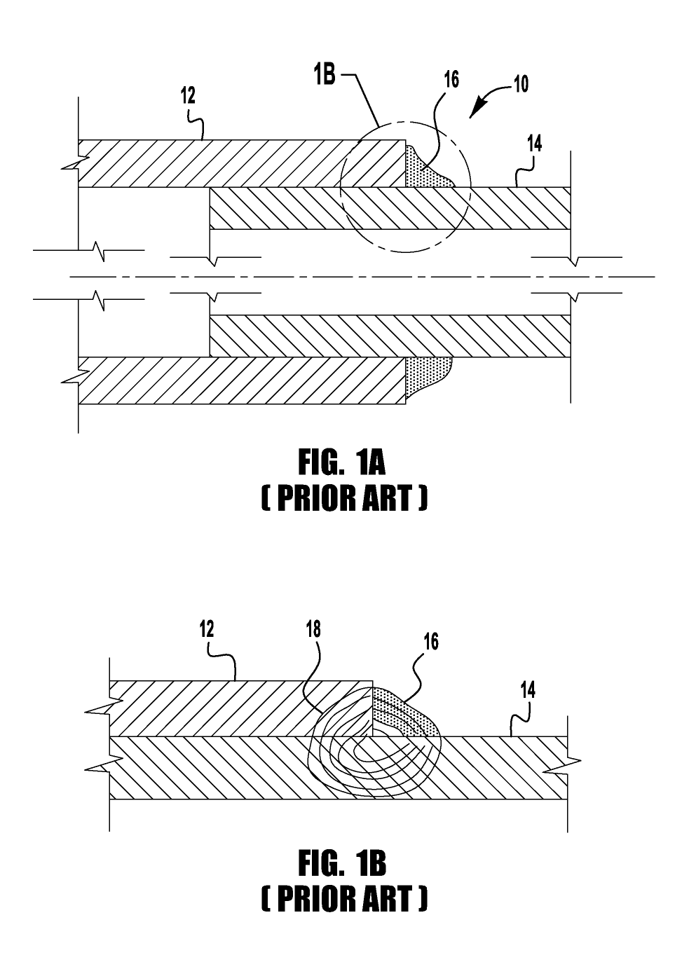

FIG. 2 is an exploded view of an exemplary pipe joint assembly;

FIG. 2A is a cross-sectional view of the pipe joint assembly of FIG. 2;

FIG. 2B is a detailed cross-sectional view of the pipe joint of FIG. 2A;

FIG. 2C is a detailed cross-sectional view of another embodiment of a pipe joint assembly;

FIG. 2D is a detailed cross-sectional view of a further embodiment of a pipe joint assembly; and

FIGS. 3A-3B schematically illustrate a hot wire system for forming the joint of FIG. 2B.

### DETAILED DESCRIPTION

Exemplary embodiments of the invention will now be described below by reference to the attached Figures. The described exemplary embodiments are intended to assist the understanding of the invention, and are not intended to limit the scope of the invention in any way. Like reference numerals refer to like elements throughout.

As an initial matter, it should be noted that even though the following discussion utilizes the joining of pipes as an exemplary embodiment, aspects of the present invention can be utilized in joining work pieces in many different configurations, including but not limited to lap joints, butt joints, angles joints, etc. Therefore, the following exemplary discussion is not intended to be limited to simply pipe joints, as the embodiments and aspects discussed herein can be equally employed in multiple joint types without departing from the scope and spirit of the present invention. Therefore, even though the following discussion utilizes a pipe embodiment, aspects of the present invention are not limited in this regard.

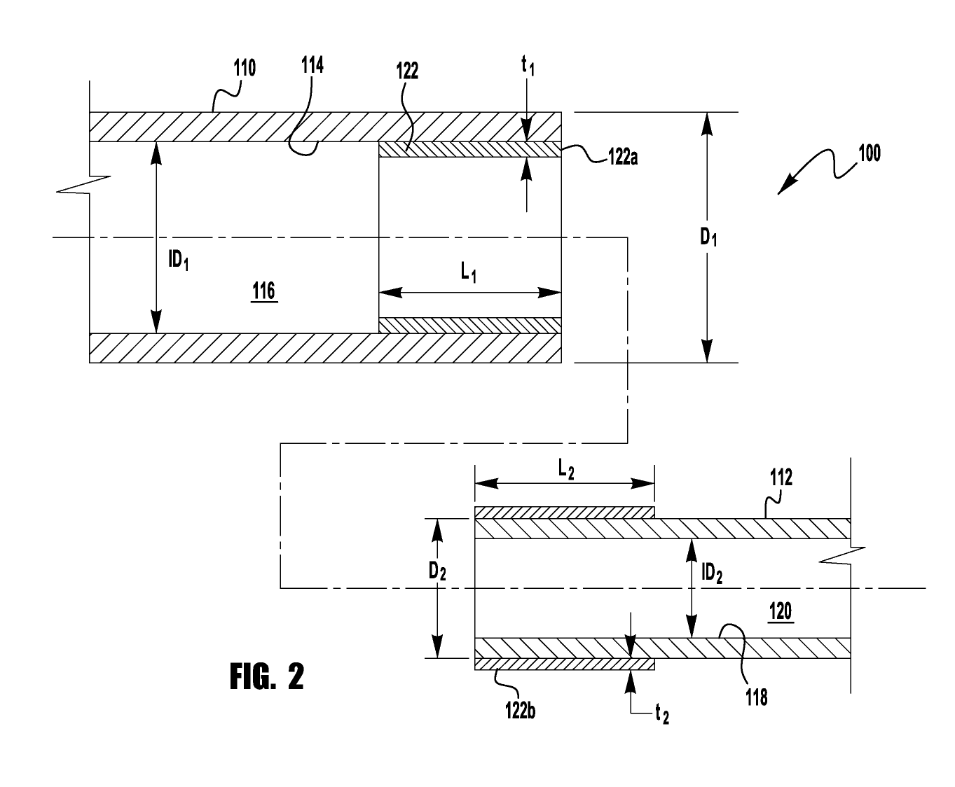

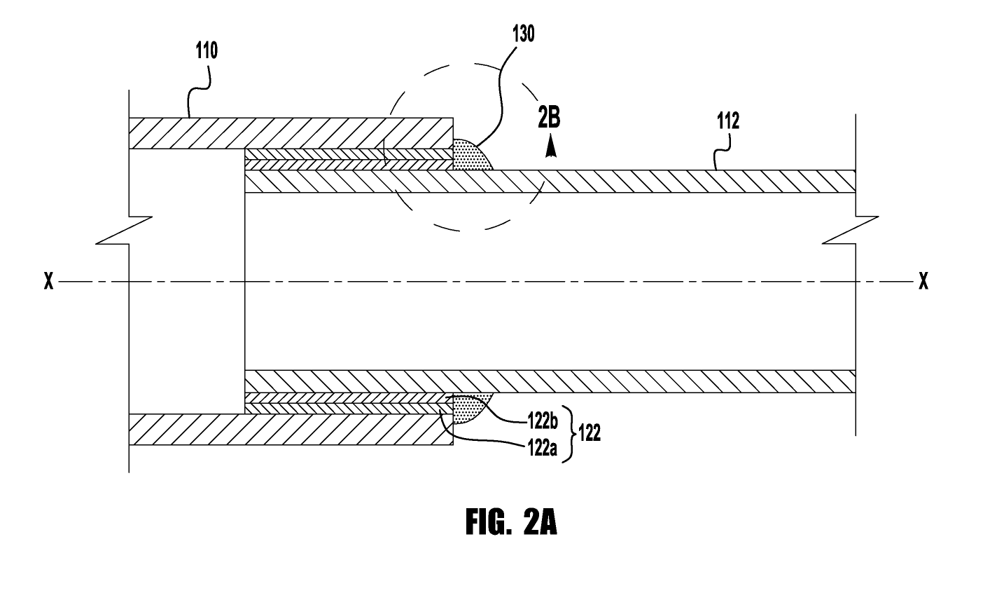

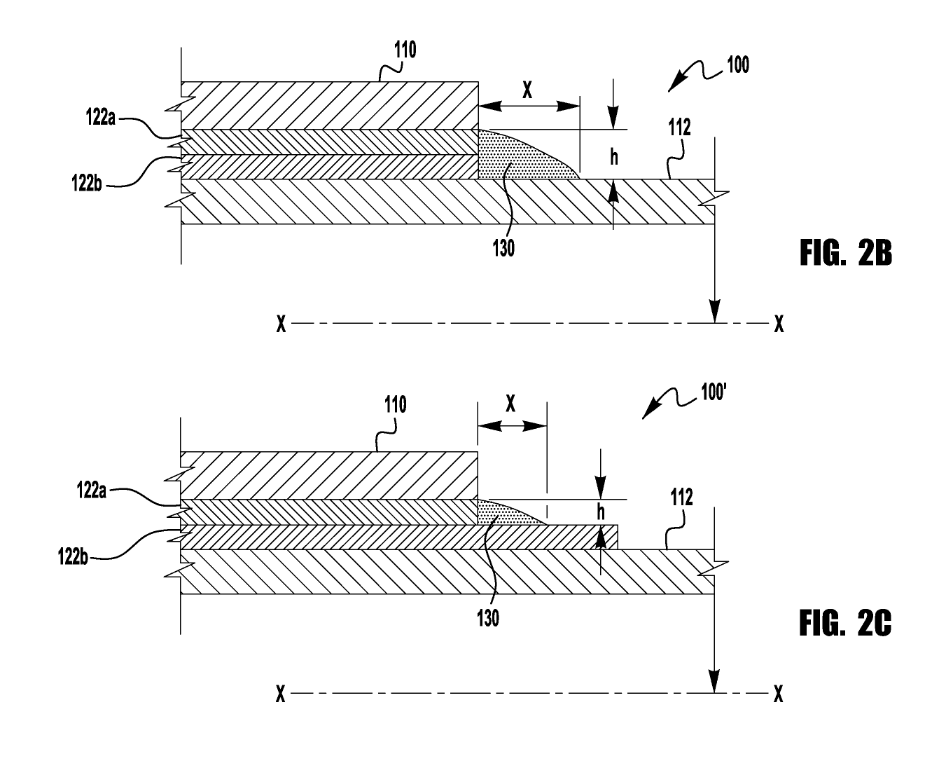

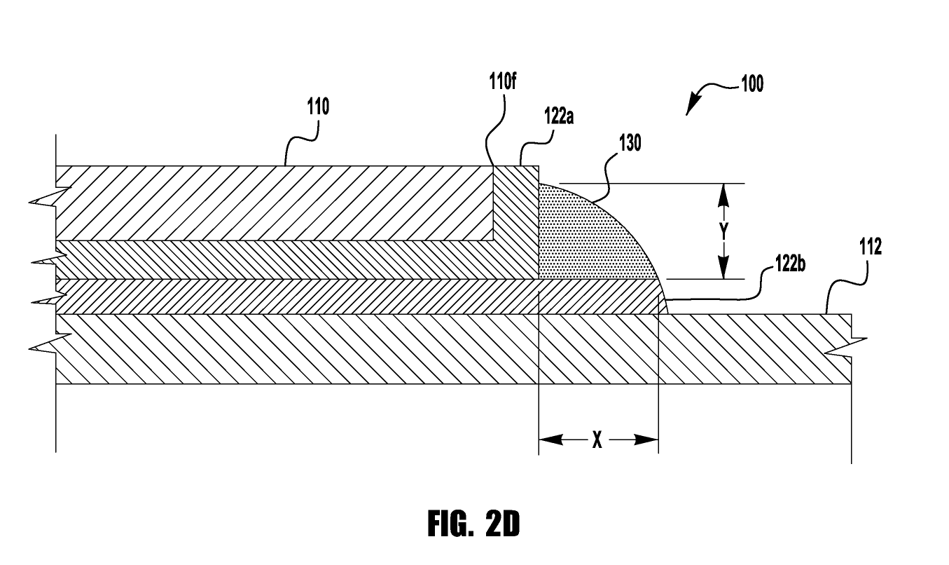

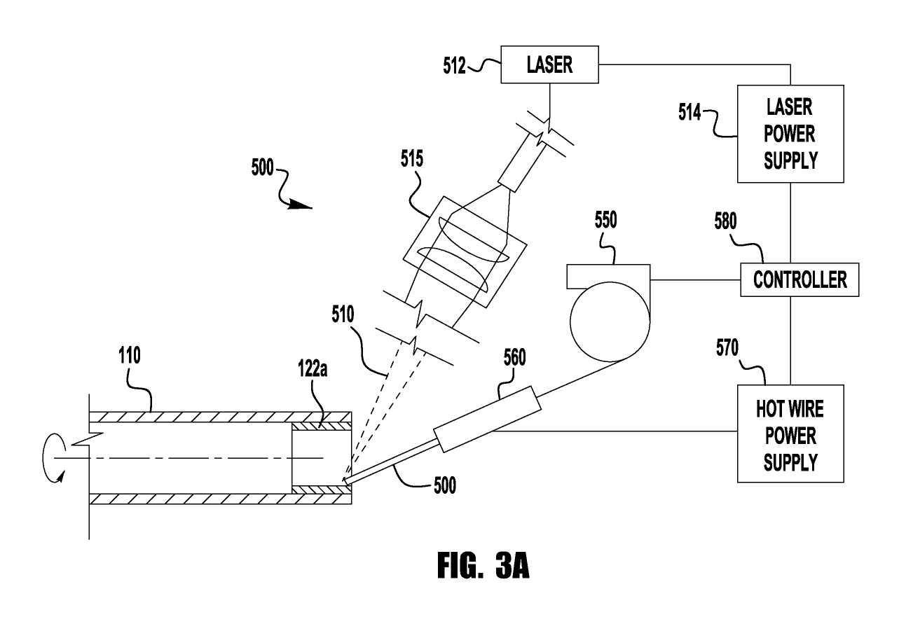

An exemplary embodiment of the invention, shown in FIG. 2 is an exploded view of an exemplary joint assembly 100 formed by a first cylindrical component 110 joined to a second cylindrical component 112. The first component defines an outer diameter and includes an inner surface 114 defining a central passageway 116 of the first component. In one particular embodiment, the first component is a pipe 110 which defines a first nominal diameter D₁. As used herein, “nominal” is a value designated about which the measurement may vary within an accepted variance. The first pipe 110 includes an inner pipe surface 114 to define the pipe passageway 116 having an inner diameter ID₁.

The assembly 100 includes a second component 112, which defines an outer dimension configured for insertion in the first component 110. In one particular embodiment of the assembly 100, the second component is a second pipe component 112 defining a second nominal diameter D₂. The second pipe component 112 includes an inner surface 118 defining a central passageway 120 of the second component having an inner diameter ID₂. For the exemplary embodiment, the first and second pipes are depicted as linear pipe segments. However, as used herein “pipe” includes linear pipe, formed pipe such as, for example, bent pipe; or pipe fittings, such as for example, T-fittings, elbow fittings.

As noted above and shown in FIG. 2A, the second pipe component 112 is disposed within the first pipe component 110 such that the end of the first pipe component 110 overlaps the end of the second pipe component 112 to form the exemplary joint 100. Disposed between the overlap of the first pipe 110 and second pipe 112 is a cladding material 122 to define an interface between the first and second pipe 110, 112. In one particular embodiment, a first clad layer 122a is formed along the inner surface 114 of the first pipe component 110. In one particular embodiment of the first clad 122a, the clad forms an internal sleeve within the pipe 110 having an axial length L₁ and a material thickness t₁. Each of these dimensions can vary based on joint and strength requirements. Alternatively or in addition to, a second clad layer 122b is disposed about the outer surface at the end of the second pipe component 112. In one particular embodiment of the second clad layer 122b, the clad forms an outer sleeve about the second pipe 112 having an axial length L₂ and a material thickness t₂.

In exemplary embodiments of the present invention, each of the clad layers 122a and 122b are applied to the pipes using a low heat input cladding operation. For example, a laser hot-wire cladding process can be used as described and disclosed in US Patent Publication Nos. 2011/0297658 and 2010/0176109 each of which is incorporated herein by reference in their entirety. Because such a cladding operation imparts lower heat input than an arc process, the HAZ in such an operation is smaller and has less of an impact on the pipes 110 and 112. Thus, each of the clad layers 122a and 112b essentially provide a substrate to absorb heat from the joining operation as described below.

Shown in FIG. 2A is a cross-sectional assembled view of the joint 100 in which the first pipe 110 has the internal clad 122a. Disposed within the first pipe 110 and its internal clad 122a is the second pipe 112 having the external outer surface clad 122b. In the embodiment shown, the first and second clad 122a, 122b substantially overlap one another and more particularly completely overlap with each defining substantially equivalent linear length L₁, L₂. In one aspect of forming the joint 100, the externally clad second pipe 112 forms an interference fit within the internal clad 122a of the first pipe 110. Other fits are possible, such as for example, a slip fit is formed between the first and second cladding 122a, 122b. The first and second pipes 110, 112 together define the joint axis X-X.

To affix and join the first pipe 110 to the second pipe 112, a weld metal 130 is formed at the axial end of the first pipe 110, and more particularly the axial end of the clad 122. The weld metal 130 joins the first pipe 110 and/or clad 122 to the adjacent outer surface of the second pipe 112. In one particular embodiment, the weld metal 130 is a fillet weld formed by any suitable welding technique including electric arc welding or a hot wire welding techniques, such as for example, GTAW. The weld metal 130 in one aspect circumferentially and continuously extends about the joint axis X-X.

Shown in FIG. 2B is a detailed view of a particular fillet weld metal 130. In one aspect, the weld metal 130 defines a height h which extends radially over the clad material 122. Moreover, the weld metal 130 extends axially along the second pipe surface an axial distance x. By forming at least a portion of the weld metal 130 along the clad 122, the clad can act as a heat sink to minimize the heat input into the base materials of the first and second pipes 110, 112. In exemplary embodiments of the present invention, the clad layers have a collective thickness such that the majority of the height h of the weld bead 130 (shown) contacts the clad layers 122 and not the pipe 110. For example, in exemplary embodiments of the present invention, the clad layers 122a and 122b have a collective thickness such that at least 50% of the height of the bead 130 contacts the clad 122. In other exemplary embodiments, the collective thickness is such that at least 75% of the height h of the bead 130 contacts the clad 122 and not the pipe 110. In further exemplary embodiments, as shown in FIG. 2A the collective thickness of the clad 122a and 122b is such that 100% of the height h of the bead 130 contacts the clad and does not contact any of the pipe 110. The above is not limited to just the height h of the bead but can also be true of the length X of the bead, where as further explained below the clad layer 122b can extend beyond the clad layer 122a on the pipe 112.

As shown in the embodiments described above, each of the layers 122a and 122b end at essentially the same spot, such that at least some of the weld 130 is directly on the pipe 112. However, in other exemplary embodiments of the present invention, at least the clad layer 122b extends beyond the edge of the pipe 110 and layer 122a such that the weld deposit 130 is almost entirely contacting the layers 122a and 122b. By doing this, each of the layers 122a and 122b can absorb the additional heat from the creation of the bead 130, whether it is an arc process or not, and because the formation of the layers 122a and 122b is a low heat process, the overall heat input into the pipes 110 and 112 is greatly minimized. Such an embodiment is shown in FIG. 2C. Accordingly, the clad layers 122a, 122b can completely overlap one another or alternative partially overlap one another. Shown in FIG. 2C is an alternate embodiment of a pipe joint assembly in which the length x of the weld metal 130 is disposed along the external clad material 122b and the height h of the weld metal 130 extends along the internal clad material 122a. Again, in such an embodiment, to the extent the welding process generates heat to be input into the weld area a large portion of the heat is to be absorbed by the cladding layers and not the underlying pipe components 110 and 112. This may reduce the need to heat treat or otherwise process the pipes 110 and 112 after the joining process.

Another exemplary embodiment of the present invention is shown in FIG. 2D. In this Figure the cladding layer 122a covers at least some of the end or front face 110f of the pipe 110 such that the bead 130 does not contact either of the pipes 110 and 112. In such embodiments, it is the cladding layers 122a and 122b which are effectively joined to each other such that each of these layers absorb most of the heat input in the welding process, preventing the need for treating either of the pipes 110 or 112 after the weld process. Thus, in these embodiments each of the width x and height y of the bead 130 is such that it does not make contact with either of the pipes 112/110 after the completed weld joint is created.

It should be noted that although the joints shown herein are standard pipe joints where one pipe is inserted into another, embodiments of the present invention are not limited to this configuration, and as discussed above other types of joints can be used without departing from the spirit or scope of the present invention.

For example, each of FIGS. 2B through 2D can equally show lap joints between two flat workpieces, which are not pipes, and aspects of the present invention, would equally apply. Furthermore, aspects of the present invention can equally be applied to butt-type and angle-type joints where the need to reduce the heat affected zone is desirable. For example, in a butt-type joint at least one (or both) of the joining surfaces can be at least partially of completely covered with a clad layer as described herein, such that the clad surfaces are joining using a welding operation as described above. Because such joints types are so well known they need not be described in detail herein. Thus, in exemplary embodiments, regardless of the joint type, at least one of the workpiece surfaces can have a clad layer as set forth herein and the weld joint/bead is joined with that clad surface as described above. For example, in any one of lap joints, butt joints, angle joints, etc. the clad layer can be such that at least one side of the weld joint is coupled to only the clad surface, as generally depicted in FIGS. 2C and 2D. Of course, the weld joint/bead can also be partially coupled to the clad layer as described above.

Furthermore, embodiments of the present invention also allow for the joining of dissimilar metals via use of a clad layer. For example, it may be desirable to join two pipes (or other workpieces) having dissimilar composition which is difficult to do using known methods. Such dissimilar metals can include chrome-molybdenum steels and stainless steels. In such embodiments, the cladding can be comprised of a nickel alloy which will bond sufficiently with the workpiece and will bond well with a welding joint 130 when created. Thus, not only can embodiments of the present invention, join workpieces with a reduced heat affected zone, they can also do so with workpieces having a different composition.

The exemplary embodiments show two pipe members being joined together. However the systems and methods described herein are not limited to forming a welded pipe joint. The subject techniques are applicable to joining two components by welding in which one component has an inner surface defining a recess for receiving a second component and where a clad surface can be formed internally or externally about the components to form a clad interface therebetween. Accordingly, the inner surface of the first component and the outer surface of the second component may define any geometry, e.g., circular, rectangular, triangular, etc., so long as they compliment one another for joining the components in a manner described herein.

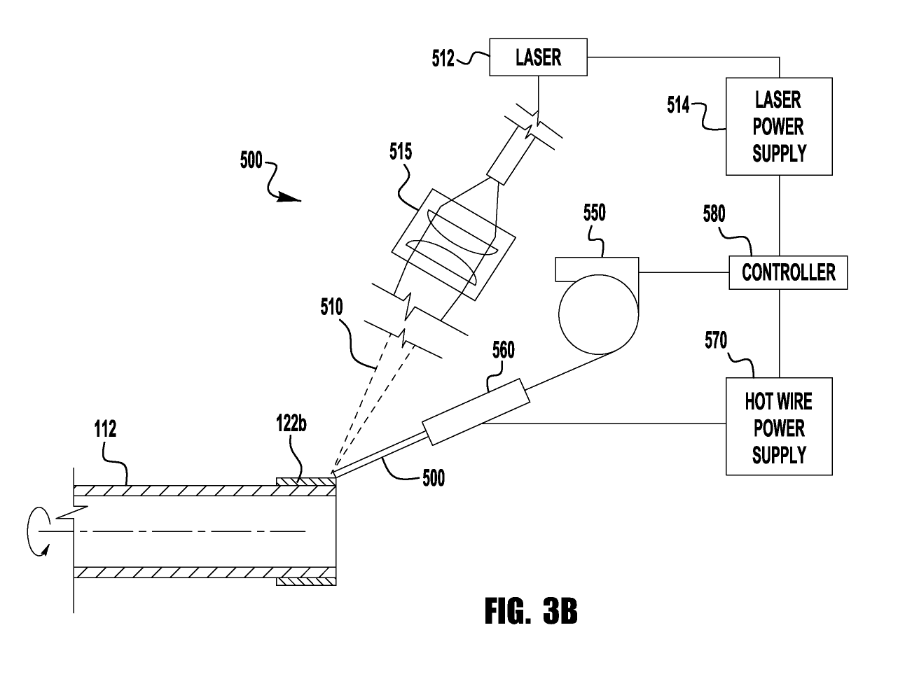

Schematically shown in each of FIGS. 3A and 3B is a hot wire system 500 for forming each of the internal clad 122a formed along the inner surface of the first pipe 110 (3A) and the external clad 122b formed along the outer surface of the second pipe 112 (3B). The system 500 for carrying out the exemplary hot wire process includes a consumable or filler wire 520 fed through a contact tube 560 which applies a heating signal voltage and/or current from a hot wire power supply 570 to heat the consumable wire 520 to its melting or near its melting point. A high intensity energy source 512, is directed to the pipe joint and the consumable wire or filler wire to generate and maintain a weld puddle within the pipe joint. The system shown is using a laser 512 as a heat source, but embodiments are not limited to the use of a laser and other high energy heat sources can be used, consistent with the descriptions herein. The consumable 520 is brought into proximity and spaced from the pipes 110, 112. The pipe assembly is mounted to rotatable mount to rotate the pipe 110, 112 about its axis with respect to the laser 512 and filler wire 520 for depositing the cladding. Additional details of the system 500, including its operation and utilization, are shown and described in U.S. Patent Publication No. 2011/0297658 and U.S. Patent Publication No. 2010/0176109, each of which is incorporated by reference in their entireties. Because the use of lasers with a hot-wire laser welding/cladding operation can result in a relatively low heat input process, embodiments of the present invention can use traditional welding methods to join pipes without the need of heat treating or processing the pipes after the joining process. Known welding consumables can have varying configurations including a solid filler wire, flux-coated and flux cored filler wires.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed.

What is claimed is:

1. A pipe joint system comprising:
a first pipe component;
a second pipe component having a partially disposed in the first pipe component to define a central joint axis;
a clad interface between the first and second pipe component; and
a weld bead joining the first pipe component to the second pipe component, the weld bead extending along a portion of the clad interface.

2. The pipe joint system of claim 1, wherein said clad interface comprises a first clad layer coupled to an inner surface of said first pipe component, and a second clad layer coupled to an outer surface of said second pipe component.

3. The pipe joint system of claim 1, wherein the clad interface has a thickness such that at least 50% of a height of said weld bead extends along said clad interface.

4. The pipe joint system of claim 1, wherein the clad interface has a thickness such that at least 75% of a height of said weld bead extends along said clad interface.

5. The pipe joint system of claim 1, wherein the clad interface has a thickness such that 100% of a height of said weld bead extends along said clad interface.

6. The pipe joint system of claim 2, wherein the axial lengths of the first and second clad layers are equivalent.

7. The pipe joint system of claim 2, wherein the axial length of the second clad layer has an extension portion that extends beyond an end point of said first clad layer and at least a portion of a length of said weld bead is coupled to said extension portion.

8. The pipe joint system of claim 2, wherein the axial length of the second clad layer has an extension portion that extends beyond an end point of said first clad layer and an entire length of said weld bead is coupled to said extension portion.

9. The pipe system of claim 1, wherein said clad interface has an extension portion that extends along an end face of at least one said first and second pipe components and said weld bead is coupled to said extension portion.

10. The pipe joint system of claim 1, wherein said clad interface comprises a first clad layer coupled to an inner surface of said first pipe component, and a second clad layer coupled to an outer surface of said second pipe component, and said weld bead contacts each of said first and second clad layers and does not contact any of said first pipe component or said second pipe component.

11. A method of forming a pipe joint, the method comprising:
forming a clad component that is to be positioned in between an inner surface of a first pipe component or an outer surface of a second pipe component;
inserting said second pipe component into said first pipe component such that said first clad component is positioned between each of said first and second pipe components; and
joining said first pipe component to said second pipe component with a weld bead where at least a portion of said weld bead is coupled to said first clad component.

12. The method of claim 11, wherein said clad component is formed by depositing a first clad layer on an inner surface of said first pipe component, and depositing a second clad layer on an outer surface of said second pipe component.

13. The method of claim 11, wherein a thickness of said clad component has a thickness such that at least 50% of a height of said weld bead extends along said clad component.

14. The method of claim 11, wherein a thickness of said clad component has a thickness such that at least 75% of a height of said weld bead extends along said clad component.

15. The method of claim 11, wherein a thickness of said clad component has a thickness such that 100% of a height of said weld bead extends along said clad component.

16. The method of claim 12, wherein axial lengths of the first and second clad layers are equivalent.

17. The method of claim 12, wherein said second clad layer has an extension portion that extends beyond an end point of said first clad layer and at least a portion of a length of said weld bead is coupled to said extension portion.

18. The method of claim 12, wherein said second clad layer has an extension portion that extends beyond an end point of said first clad layer and an entire length of said weld bead is coupled to said extension portion.

19. The method of claim 11, wherein said clad component is formed with an extension portion that extends along an end face of at least one said first and second pipe components and said weld bead is coupled to said extension portion.

20. The method of claim 11, wherein said clad component is formed by depositing a first clad layer on an inner surface of said first pipe component, and depositing a second clad layer on an outer surface of said second pipe component, and said weld bead is formed such that said weld bead contacts each of said first and second clad layers and does not contact any of said first pipe component or said second pipe component.

21. A joint system comprising:
a first component having a first surface;
a second component having a second surface to be joined to said first surface;
a clad interface between the first and second components and between said first and second surfaces; and
a weld bead joining the first component to the second component, the weld bead extending along a portion of the clad interface.

22. The joint system of claim 21, wherein said first component has a different material composition from said second component.
